(19) United States
(12) Patent Application Publication
(10) Pub. No.: US 2025/0269757 A1
(43) Pub. Date: Aug. 28, 2025

(54) DISPATCH SYSTEM AND METHOD FOR BATTERY ELECTRIC MACHINES

(71) Applicant: Caterpillar Inc., Peoria, IL (US)

(72) Inventors: Russell Brockhurst, Carindale (AU); Stefan Jacob Wulf, Washington, IL (US)

(73) Assignee: Caterpillar Inc., Peoria, IL (US)

(21) Appl. No.: 18/588,122

(22) Filed: Feb. 27, 2024

(51) Int. Cl. B60L 53/68; B60L 53/14; B60L 53/62; B60L 53/67; G06Q 10/0631; G06Q 50/06

(52) U.S. Cl. CPC B60L 53/68; B60L 53/14; B60L 53/62; B60L 53/67; G06Q 10/06313; G06Q 10/06316; G06Q 50/06

(57) ABSTRACT

A dispatch system and method for battery electric machines is disclosed. The dispatch system includes a processor configured to receive battery information from the battery electric machines and assign first battery electric machines for operation based on the battery information. The processor is also configured to station second battery electric machines at one or more charging stations. Further, the processor is configured to selectively recall at least one assigned first battery electric machine to a designated charging station. In addition, the processor is configured to selectively dispatch at least one stationed second battery electric machine for operation from the charging stations. Furthermore, the processor is configured to maintain a number of the battery electric machines at each charging station substantially constant over time. The dispatch method includes steps performed by the dispatch system.

### TECHNICAL FIELD

The present disclosure relates in general to computer-implemented dispatch systems and methods for battery electric machines.

### BACKGROUND

In electrified work environments including, but not limited to, electrified mine sites, multiple Battery Electric Machines (BEMs) may be deployed for performing one or more tasks. Such BEMs may be required to be charged periodically to keep the BEMs in continued operation to perform and complete the tasks. Typically, charging BEMs is a time-consuming process and may result in underutilization of operators handling the BEMs during the charging period. Moreover, a number of charging stations available at the electrified mine sites may be limited. Hence, a number of BEMs that require charging at a given point in time may, in some instances, be greater than the number of charging stations or the number of charging points at each charging station. Such instances may result in queuing of the BEMs at the charging stations/points, and further result in underutilization of the BEMs as well as the operators handling the queued BEMs. In other instances, the number of BEMs stationed for charging at each charging station may also be less than a number of charging points provided at each charging station. Accordingly, the multiple charging points may be left unused and thereby, result in underutilization of the charging stations. Consequently, the underutilization of at least one of the BEMs, the operators handling the BEMs and/or the charging stations may result in decreased productivity and/or delay in completion of the tasks besides incurring increased operational costs and overheads related the operators, the BEMs, and/or the charging stations.

U.S. Pat. No. 11,603,006 relates to a vehicle dispatching system and a vehicle dispatching method. The vehicle dispatching system accepts a dispatch request from a user, selects an autonomous vehicle matching with the dispatch request from among a plurality of autonomous vehicles, and dispatches a selected autonomous vehicle to the user. The plurality of autonomous vehicles include a plurality of battery-mounted vehicles having an in-vehicle battery capable of being charged externally as an energy source. Each of the plurality of battery-mounted vehicles performs charging at a charging station when a charging level of the in-vehicle battery decreases. The vehicle dispatching system comprises a management server including a processor for executing programs stored in memory, the management server programmed to act as a charging planning unit that changes an upper limit charging level of the in-vehicle battery when charging at the charging station according to a time slot. However, changing the upper limit charging level of the in-vehicle battery at the charging station by the vehicle dispatching system merely enables the autonomous vehicle to be dispatched in response to the user request. On the other hand, at electrified mine sites involving multiple machine operators, machines, and charging stations optimal utilization of the machine operators, the machines, and the charging stations may become necessary to improve overall operational efficiency.

### SUMMARY

In an aspect of the present disclosure, a dispatch system for a plurality of battery electric machines is disclosed. The dispatch system includes a processor and a memory communicatively coupled to the processor. The dispatch system also includes a transceiver configured for communication with the plurality of battery electric machines (BEMs). The memory stores instructions which, upon execution by the processor, cause the processor to receive battery information from the plurality of BEMs via the transceiver. Based on the battery information, the processor is configured to assign one or more first battery electric machines of the multiple BEMs for operation. The processor is also configured to station one or more second battery electric machines of the multiple BEMs at one or more charging stations. Further, the processor is configured to selectively recall at least one first battery electric machine to a designated charging station. In addition, the processor is configured to selectively dispatch at least one second battery electric machine for operation from the one or more charging stations. Furthermore, the processor is configured to maintain a number of the battery electric machines at each charging station of the one or more charging stations substantially constant over time.

In another aspect of the present disclosure, a dispatch system for dispatching the battery electric machines from a charging station is disclosed. The dispatch system includes a processor and a memory communicatively coupled to the processor. The dispatch system also includes a transceiver configured for communication with the plurality of battery electric machines. The memory stores instructions which, upon execution by the processor, cause the processor to receive battery information from the plurality of battery electric machines respectively via the transceiver. Based on the battery information, the processor is configured to assign one or more first battery electric machines of the multiple battery electric machines for operation. Each first battery electric machine may be operated by an operator. The processor may also be configured to station one or more second battery electric machines of the multiple battery electric machines at the charging station. The charging station includes at least one charging rail and the second battery electric machines are stationed along a first charging rail. Further, the processor is configured to selectively recall at least one assigned first battery electric machine of the assigned first battery electric machines to a second charging rail of the charging rails. In addition, the processor is configured to selectively dispatch at least one stationed second battery electric machine of the stationed second battery electric machines for operation from the first charging rail. Furthermore, the processor is configured to recall the assigned first battery electric machine prior to selectively dispatching the second battery electric machine in order to facilitate a transfer of the operator operating the recalled first battery electric machine to the stationed second battery electric machine selected for dispatch. The processor is also configured to maintain a number of the battery electric machines along at least one charging rail of the charging rails substantially constant over time.

In another aspect of the present disclosure, a system for managing operation of multiple battery electric machines at a site is disclosed. The system includes one or more charging stations and a dispatch system for the battery electric machines. The dispatch system is configured to receive battery information from the battery electric machines respectively. Based on the battery information, the dispatch system is configured to assign one or more first battery electric machines of the multiple battery electric machines for operation at the work site. The dispatch system is also configured to station one or more second battery electric machines of the multiple battery electric machines at the charging stations. Further, the dispatch system is configured to selectively recall at least one first battery electric machine to a designated charging station. In addition, dispatch system is configured to selectively dispatch at least one second battery electric machine for operation. The dispatch system is also configured to maintain a number of the battery electric machines at each charging station substantially constant over time.

In yet another aspect of the present disclosure, a dispatch method for multiple battery electric machines is disclosed. The method includes a step of receiving battery information from the multiple battery electric machines respectively. The method also includes a step of assigning one or more first battery electric machines of the multiple battery electric machines for operation based on the battery information. Further, the method also includes a step of stationing one or more second battery electric machines of the multiple battery electric machines at one or more charging stations based on the battery information. In addition, the method includes a step of selectively recalling the at least one first battery electric machine to a designated charging station based on the battery information. Furthermore, the method also includes a step of selectively dispatching the at least one second battery electric machine for operation. The method also includes a step of maintaining a number of the battery electric machines at each charging station substantially constant over time.

### BRIEF DESCRIPTION OF DRAWINGS

FIG. 1 is an exemplary diagrammatic illustration of a system for managing operation of multiple battery electric machines at a work site, in accordance with some embodiments of the present disclosure;

FIG. 2 is an exemplary diagrammatic illustration of a charging station provided in the system of FIG. 1, in accordance with some embodiments of the present disclosure;

FIG. 3 is an exemplary diagrammatic illustration of a charging station provided in the system of FIG. 1, in accordance with some other embodiments of the present disclosure;

FIG. 4 is a schematic illustration of a dispatch system of the system of FIG. 1 for the multiple battery electric machines, in accordance with some embodiments of the present disclosure;

FIGS. 5-8 are exemplary diagrammatic illustrations of recalling first battery electric machines to, and dispatching second battery electric machines from, the charging station of FIGS. 2-3, in accordance with various embodiments of the present disclosure;

FIG. 9 is an exemplary diagrammatic illustration of recalling first battery electric machines to, and dispatching second battery electric machines from, charging rails provided in the charging station of FIGS. 2-3, in accordance with some embodiments of the present disclosure;

FIG. 10 is an exemplary diagrammatic illustration of recalling the dispatched second battery electric machines to, and dispatching the recalled first battery electric machines from, the charging rails provided in the charging station of FIG. 3, in accordance with some embodiments of the present disclosure; and

FIG. 11 is an exemplary flowchart of a dispatch method for the battery electric machines, in accordance with some embodiments of the present disclosure.

### DETAILED DESCRIPTION

Reference will now be made in detail to specific embodiments or features, examples of which are illustrated in the accompanying drawings. Generally, corresponding reference numbers may be used throughout the drawings to refer to the same or corresponding parts, e.g., 1, 1′, 1″, 101 and 201 could refer to one or more comparable components used in the same and/or different depicted embodiments.

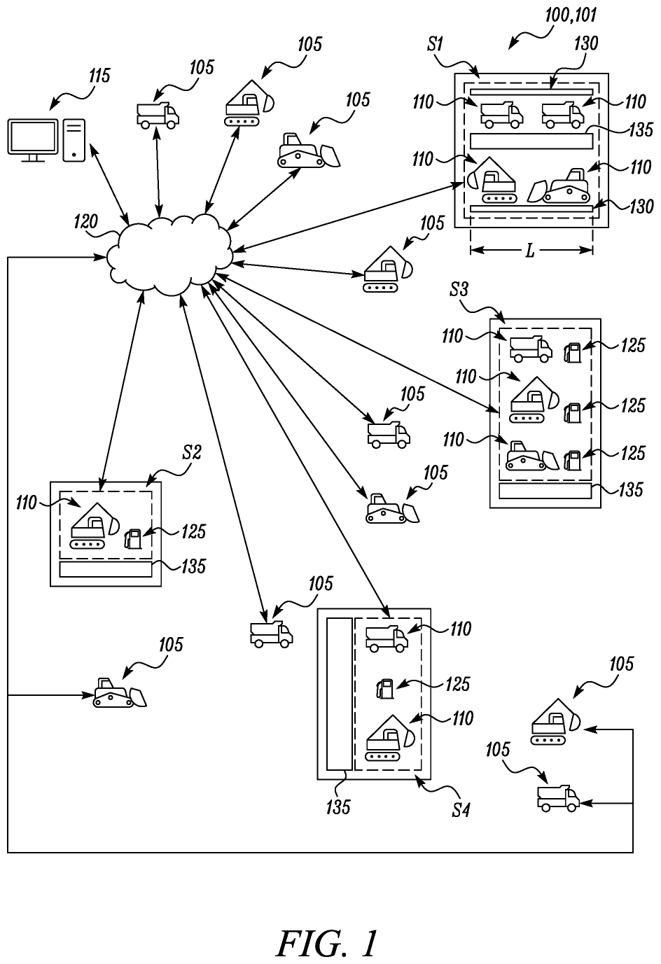

Referring to FIG. 1, an exemplary diagrammatic illustration of a system 100 for managing operations of multiple battery electric machines 105, 110 at a work site 101 is disclosed. Examples of the work site 101 include, but are not limited to, an electrified mining site, quarry, construction site, and/or warehouse. Examples of the battery electric machines 105, 110 include, but are not limited to, haul trucks, water trucks, loaders, excavators, shovels, and tractors. The system 100 includes and a dispatch system 115 for the battery electric machines 105, 110 and one or more charging stations, for example, S1, S2, S3, and S4. In some embodiments, the dispatch system may be in communication with the battery electric machines 105, 110 via a network 120. Examples of the network 120 include, but are not limited to, a Local Area Network (LAN), a Wireless Local Area Network (WLAN), a Small Area Network (SAN), a Wi-Fi Direct Network and a telecommunication network including, but not limited to, a fourth generation (4G) and a fifth generation (5G) cellular network.

In some embodiments, the dispatch system 115 may be configured to receive battery information from the battery electric machines 105, 110 respectively via the network 120. Based on the battery information, the dispatch system 115 may be configured to assign one or more first battery electric machines 105 of battery electric machines 105, 110 for operation at the work site 101. The dispatch system 115 may also be configured to station one or more second battery electric machines 110 of the battery electric machines 105, 110 at the charging stations S1, S2, S3, and/or S4. Further, the dispatch system 115 may be configured to recall at least one first battery electric machine 105 to a designated charging station, for example, S1, of the charging stations S1-S4. In addition, the dispatch system 115 may be configured to dispatch at least one second battery electric machine 110 for operation. The dispatch system 115 may assign, station, recall, and/or dispatch the first battery electric machines 105 and/or the second battery electric machines 110 such that a number of the of battery electric machines 105, 110 at each charging station, for example, S1, is substantially constant over time.

In some embodiments, the charging stations S1-S4 may be provided at one or more predefined locations. In some embodiments, the dispatch system 115 may also be configured to determine the predefined locations based one or more site parameters. Examples of the site parameters include, but are not limited to, one or more operations to be performed at the work site 101, a time required to complete the operation(s), a frequency of the operation(s) to be performed, a criticality of the operation(s) to be performed, a feasibility of installing the charging stations S1-S4 at the work site 101, and/or a location and/or a number of electric power supply sources at the site. Each charging station, for example, S1, may include one or more charging points 125 or charging rails 130 and one or more operator rooms 135. In some embodiments, the operator rooms 135 may include items such as, but not limited to, bed(s), restroom(s), and chair(s), for rest, recovery, and/or refreshment of operators operating the battery electric machines 105 and/or 110. Each charging station may have a predefined power supply capacity and a number of the battery electric machines 105, 110 that may be charged at each charging station simultaneously may be dependent on the predefined power supply capacity of each charging station. For example, the charging stations S1, S2, S3, and S4 may respectively be capable of charging four, one, three, and two battery electric machines 105, 110 simultaneously depending on the predefined power supply capacity of the charging stations S1-S4. In some embodiments, number of the battery electric machines 105, 110 that may be charged at each charging station simultaneously may also be dependent on a number of the charging points 125 provided in each charging station. In some embodiments, number of the battery electric machines 105, 110 that may be charged at each charging station simultaneously may also be dependent on a number of the battery electric machines 105, 110 that may be accommodated along a length ‘L’ of the charging rails 130.

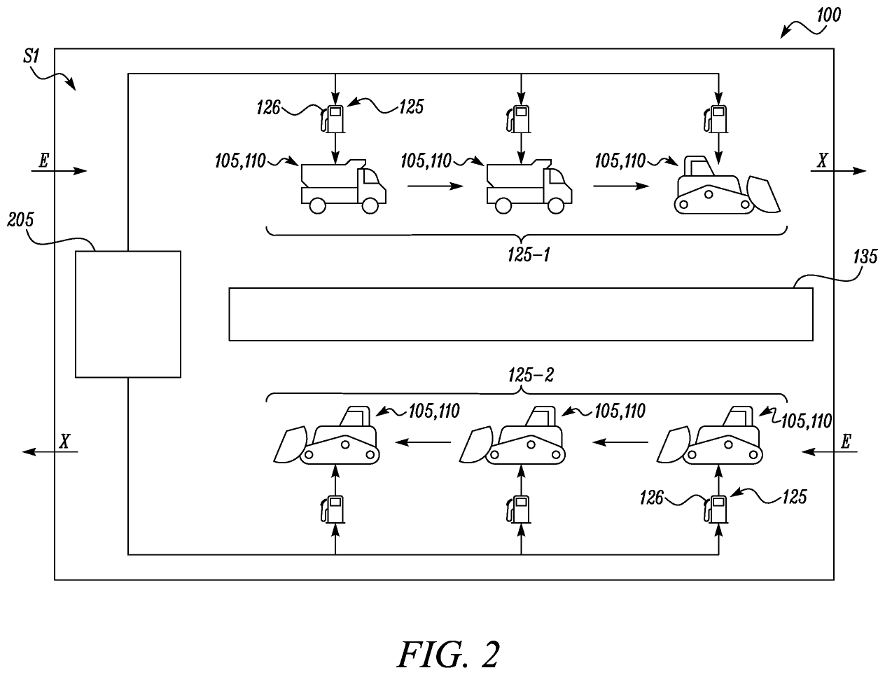

Referring to FIG. 2, an exemplary diagrammatic illustration of the charging station S1 in accordance with some embodiments of the present disclosure is disclosed. The battery electric machines 105 and/or 110 may be stationed in the charging station S1. The charging station S1 may include one or more power units 205, one or more charging points 125 powered by and in communication with the power unit(s), and the operator room 135. The power units 205 may correspond to one or more electrical power sources having a predefined power capacity. Each charging point 125 may include one or more charging connectors 126 configured to be detachably connected to and charge the battery electric machines 105 and/or 110. It may be apparent that the battery electric machines 105, 110 may include one or more charging ports (not shown) that may be configured to be coupled with the charging connector(s) 126 of the charging point(s) 125. In some embodiments, the charging station S1 may be configured to include one or more rows of multiple charging points 125. In some embodiments, the operator room(s) 135 may be positioned between and/or adjacent to each row of the multiple charging points 125. In some embodiments, the battery electric machines 105 and/or 110 may be stationed at at least one of or all the charging points 125. In some embodiments, the battery electric machines 105 and/or 110 may be stationed in at least one of the multiple rows 125-1, 125-2 of the charging points 125 or in all the rows 125-1, 125-2 of the charging points 125.

In some embodiments, the charging station S1 may also include one or more entry points ‘E’ and/or exit points ‘X’ for each row, for example, 125-1, 125-2, of the charging points 125. In some embodiments, the entry points ‘E’ and/or the exit points ‘X’ for a first row 125-1 of charging points 125 may be configured such that the battery electric machines 105 and/or 110 in the first row 125-1 are in a first direction and the battery electric machines 105 and/or 110 in the second row 125-2 are in a second direction. In some embodiments, the first direction and the second direction may be the same. In some embodiments, the second direction may be different from and/or opposite to the first direction. It may be understood that the battery electric machines 105 and/or 110 dispatched from the first row 125-1 and/or second row 125-2 may exit the charging station S1 through the exit points ‘X’ provided in the first row 125-1 and/or second row 125-2. Similarly, it may be understood that the battery electric machines 105 and/or 110 stationed and/or recalled to the charging station S1 may enter the charging station S1 through the entry points ‘E’ provided in the first row 125-1 and/or second row 125-2.

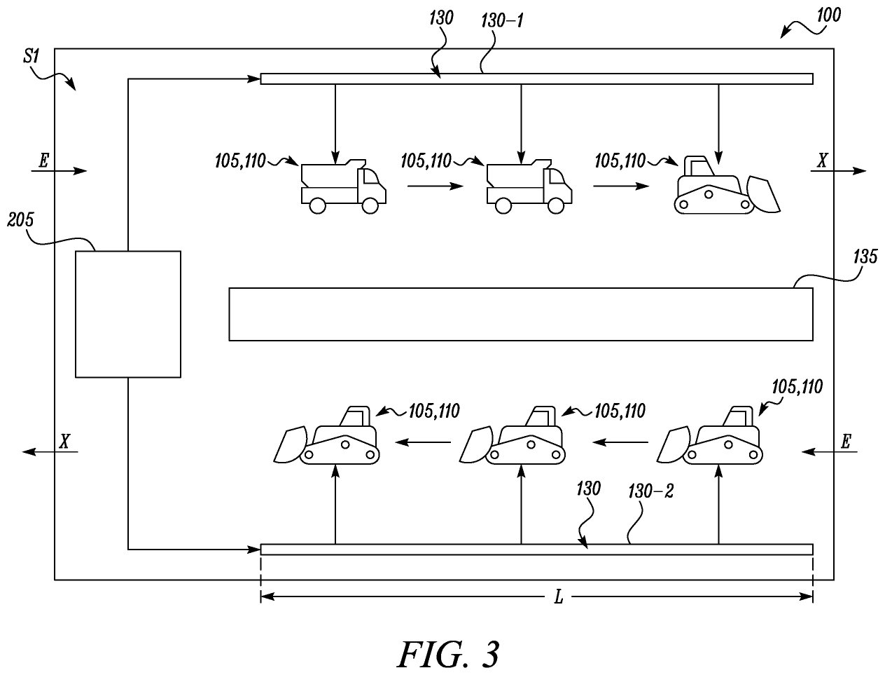

Referring to FIG. 3, an exemplary diagrammatic illustration of the charging station S1 in accordance with some other embodiments of the present disclosure is disclosed. The battery electric machines 105 and/or 110 may be stationed in the charging station S1. The charging station S1 may include one or more power units 305, one or more charging rails 130 powered by and in communication with the power unit(s) 205, and the operator room 135. In some embodiments, the charging rails 130 may include one or more connection means (not shown) for connection with the battery electric machines 105, 110. Examples of the connection means include, but are not limited to, slots, grooves, and protrusions. In some embodiments, the connection means may extend along the length ‘L’ of the charging rails 130. It may be apparent that the battery electric machines 105, 110 may include one or more charging connectors or arms (not shown) that may be configured to be coupled with the charging rail(s) 130. In some embodiments, the charging rails 130 may charge the battery electric machines 105, 110 when the charging connectors are coupled with the connection means. In some embodiments, the charging rails 130 may be configured to continuously charge the battery electric machines 105, 110 as the battery electric machines 105, 110 move along the length ‘L’ of the charging rails 130. In some embodiments, the charging station S1 may also be configured to include multiple charging rails 130 positioned parallelly and/or at a predefined distance for each other. In some embodiments, the operator room(s) 135 may be positioned between and/or adjacent to the multiple charging rails 130. In some embodiments, the battery electric machines 105 and/or 110 may be stationed along at least one of the charging rails 130-1, 130-2 of the charging rails 130 or in along both the charging rails 130-1, 130-2 of the charging rails 130.

In some embodiments, the charging station S1 may also include one or more entry points ‘E’ and/or exit points ‘X’ for each charging rail, for example, 130-1 or 130-2, of the charging rails 130. In some embodiments, the entry points ‘E’ and/or the exit points ‘X’ for a first charging rail 130-1 of charging rails 130 may be configured such that the battery electric machines 105 and/or 110 along the first charging rail 130-1 are in a first direction and the battery electric machines 105 and/or 110 along the second charging rail 130-2 are in a second direction. In some embodiments, the first direction and the second direction may be the same. In some embodiments, the second direction may be different from and/or opposite to the first direction. It may be understood that the battery electric machines 105 and/or 110 dispatched from the first charging rail 130-1 and/or second charging rail 130-2 may exit the charging station S1 through the exit points ‘X’ provided in the first charging rail 130-1 and/or second charging rail 130-2. Similarly, it may be understood that the battery electric machines 105 and/or 110 stationed and/or recalled to the charging station S1 may enter the charging station S1 through the entry points ‘E’ provided in the first charging rail 130-1 and/or second charging rail 130-2. It may be understood that the battery electric machines 105 and/or 110 may be charged by the charging rails 130 when connected to the charging rails 130. It may also be understood that the battery electric machines 105 and/or 110 may move along the charging rails 130 while being connected to the charging rails 130 such that the battery electric machines 105 and/or 110 being recalled through the entry points ‘E’ may be connected to the charging rails 130 in series with the moving battery electric machines 105 and/or 110, or the battery electric machines 105 and/or 110 moving towards the exit points ‘X’ may be disconnected from the charging rails 130 and dispatched in series from the charging station S1. In some embodiments, the first charging rail 130-1 and the second charging rail 130-2 may be the same and provided on opposite sides of the same charging rail 130.

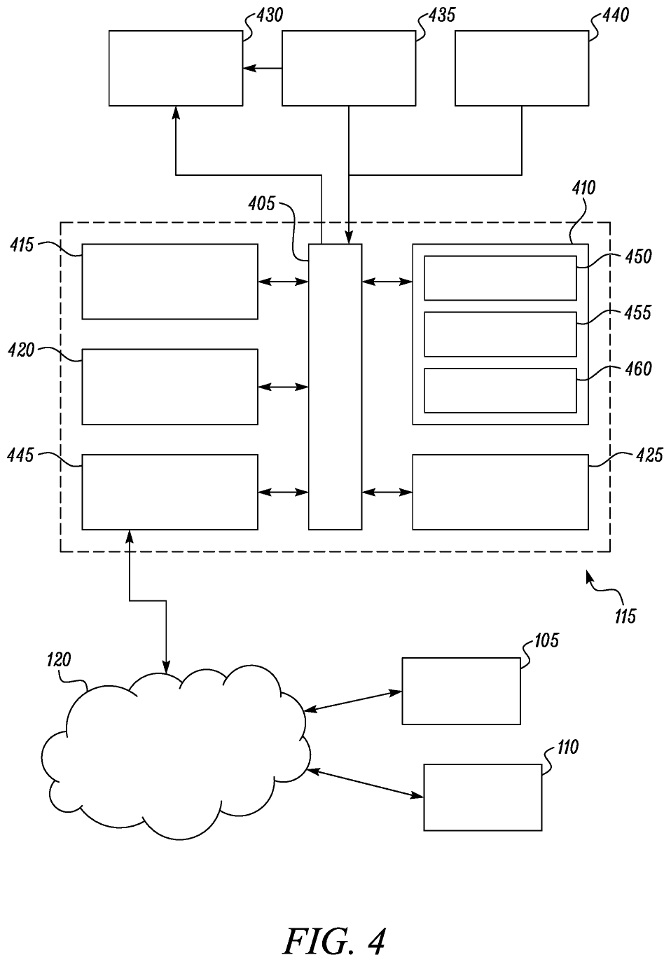

It may be apparent that the remaining charging stations S2-S4 may be configured similar to or substantially similar to the charging station S1 as shown in FIG. 3 or FIG. 4 and hence, detailed description for the remaining charging stations S2-S4 is omitted for brevity. It may also be apparent that the charging stations S1-S4 may be configured to include a combination of the charging points 125 as shown in FIG. 3 and the charging rails 130 as shown in FIG. 4.

Referring to FIG. 4, a schematic illustration of the dispatch system 115 of FIG. 1 is disclosed. The dispatch system 115 includes a bus 405 or other communication mechanism for communicating information, and a processor 410 coupled with the bus 405 for processing information. The dispatch system 115 also includes a memory 415, such as a random-access memory (RAM) or other dynamic storage device, coupled to the bus 405 for storing information and instructions to be executed by the processor 410. The memory 415 can be used for storing temporary variables or other intermediate information during execution of instructions to be executed by the processor 410. The dispatch system 115 further includes a read only memory (ROM) 420 or other static storage device coupled to bus 405 for storing static information and instructions for the processor 410.

A storage unit 425, such as a magnetic disk or optical disk, is provided and coupled to the bus 405. The storage unit 425 may store predefined machine related information corresponding to the battery electric machines, for example, 105, 110 respectively. The predefined machine related information corresponding to each battery electric machine may include, but is not limited to, a type of the battery electric machine, a utility associated with the battery electric machine, one or more operations to be performed by the battery electric machine, a time required to complete the operation(s) by the battery electric machine, a criticality associated with the operation(s), and battery information associated with the battery electric machine. Examples of the battery information corresponding to each battery electric machine includes, but is not limited to, a battery charging capacity associated with the battery electric machine, an amount of a battery charge determined in the battery electric machine, a number of a battery charge cycle in the battery electric machine, an operating range of the battery electric machine determined based on the amount of the battery charge, a predefined threshold battery charge corresponding to the battery electric machine, a target battery charge corresponding to the battery electric machine required to perform the operation(s), a state of the battery or batteries, and a criticality of the amount of the battery charge determined based on a predefined threshold battery charge. In some embodiments, the state of the battery may correspond to, but is not limited to, a consumption state and a charging state. The consumption state may indicate that the battery electric machine(s) 105, 110 is in operation and consuming the energy stored in the battery. The charging state may indicate that the battery electric machine(s) 105, 110 is charging. In some embodiments, the storage unit 425 may also store one or more machine learning, artificial intelligence, logical, and/or conditional modules, algorithms, and/or models.

In some embodiments, the storage unit 425 may also store charging station related information corresponding to the charging stations, for example, S1-S4 (see FIG. 1) respectively. Examples of the charging station related information include, but is not limited to, a number of the charging points 125 (see FIG. 2) and a number of rows of the charging points 125 provided at each charging station, a number of charging rails 130 (see FIG. 3) provided at each charging station, a total number of battery electric machines 105, 110 that can be accommodated in each charging station, a number of battery electric machines 105, 110 that can be accommodated in each row of the charging points 125, and/or a number of the battery electric machines 105, 110 that can be accommodated in each charging rail of the charging rails 130. It may be understood that the information stored in the storage unit 425 may be accessed by the processor 410 via the memory 415 to perform one or more functions.

The dispatch system 115 can be coupled via the bus 405 to a display 430, such as a light emitting diode (LED) and a liquid crystal display (LCD) for displaying information to an operator. An input device 435 is coupled to bus 405 for communicating information and command selections to the processor 410. The input device 435 may be included in the display 430, for example a touch screen that facilitates detection of multi-touch inputs from the user via the display 430. The input device 435 may also correspond to peripheral input devices that may be paired with the dispatch system 115 via Bluetooth, Wi-Fi, Wi-Fi direct, or as a hardware connection such a USB peripheral to the dispatch system 115. Examples of the peripheral input devices include, but are not limited to, a joystick, a gamepad, a keyboard, a mouse, a gesture-controlled device, or a wearable device such as, for example, a smart watch. In some embodiments, the input device 435 may also correspond to a microphone (not shown) provided in the dispatch system 115 that is configured to received audio inputs or instructions from one or more operators. In some embodiments, the input device 435 may also include alphanumeric and other keys. Another type of user input device is an input control 440, such as a mouse, a trackball, or cursor direction keys for communicating direction information and command selections to the processor 410 and for controlling cursor movement on the display 430.

Various embodiments are related to the use of dispatch system 115 for implementing the techniques described herein. In one embodiment, the techniques are performed by the dispatch system 115 in response to the processor 410 executing instructions included in the memory 415. Such instructions can be read into the memory 415 from another machine-readable medium, such as the storage unit 425. Execution of the instructions included in the memory 415 causes the processor 410 to perform the process steps described herein.

The term “machine-readable medium” as used herein refers to any medium that participates in providing data that causes a machine to operate in a specific fashion. In an embodiment implemented using the dispatch system 115, various machine-readable medium is involved, for example, in providing instructions to the processor 410 for execution. The machine-readable medium can be a storage media. Storage media includes both non-volatile media and volatile media. Non-volatile media includes, for example, optical or magnetic disks, such as storage unit 425. Volatile media includes dynamic memory, such as the memory 415. All such media must be tangible to enable the instructions carried by the media to be detected by a physical mechanism that reads the instructions into a machine. Common forms of machine-readable medium include, for example, a floppy disk, a flexible disk, hard disk, magnetic tape, or any other magnetic medium, a CD-ROM, any other optical medium, punch cards, paper-tape, any other physical medium with patterns of holes, a RAM, a PROM, and EPROM, a FLASH-EPROM, any other memory chip, or cartridge.

In another embodiment, the machine-readable medium can be a transmission media including coaxial cables, copper wire and fibre optics, including the wires that comprise the bus 405. Transmission media can also take the form of acoustic or light waves, such as those generated during radio-wave and infra-red data communications. Examples of machine-readable medium may include, but are not limited, to a carrier wave as described hereinafter or any other medium from which the dispatch system 115 can read, for example online software, download links, installation links, and online links. For example, the instructions can initially be carried on a magnetic disk of a remote computer. The remote computer can load the instructions into its dynamic memory and send the instructions over a telephone line using a modem. A modem local to the dispatch system 115 can receive the data on the telephone line and use an infra-red transmitter to convert the data to an infra-red signal. An infra-red detector can receive the data carried in the infra-red signal and appropriate circuitry can place the data on the bus 405. The bus 405 carries the data to the memory 415, from which the processor 410 retrieves and executes the instructions. The instructions received by the memory 415 can optionally be stored in the storage unit 425 either before or after execution by the processor 410.

The dispatch system 115 also includes a transceiver 445 coupled to the bus 405. The transceiver 445 provides a two-way data communication coupling with the battery electric machines 105, 110. For example, the transceiver 445 can be an integrated service digital network (ISDN) card or a modem to provide a data communication connection to a corresponding type of telephone line. As another example, the transceiver 445 can be a local area network (LAN) card to provide a data communication connection to a compatible LAN. Wireless links can also be implemented. In any such implementation, the transceiver 445 sends and receives radio, electrical, electromagnetic, or optical signals that carry digital data streams representing various types of information.

In some embodiments, the processor 410 may be capable of executing the computer instructions stored in the memory 415 to perform one or more functions. In some embodiments, the processor 410 may include one or more modules 450-460 to perform the one or more functions. For example, the processor 410 may include an identification module 450, an assignment module 455, and a dispatch module 460. It may be understood that the modules 450-460 may correspond to and/or include hardware and/or software components respectively and may be configured to perform respective functions. It may also be understood that, in some embodiments, the modules 450-460 may implement one or more machine learning, artificial intelligence, logical, and/or conditional operations, modules, algorithms, and/or models to perform respective functions.

For example, the identification module 450 may be configured to determine the predefined locations to set-up the charging stations S1-S4 (see FIG. 1). In some embodiments, the identification module 450 may be configured to determine the predefined locations based the site parameters. In some embodiments, the identification module 450 may also be configured to determine a number of charging points 125 and/or rails 130 that can be installed at each charging station based on one or more set-up parameters. Examples of the set-up parameters include, but are not limited, the power capacity of the power unit(s) 205 (see FIGS. 2-3) at the predefined location, a physical space or real-estate available to set-up the charging station, a feasibility of accessing the predefined location determined, and a proximity of the predefined location to one or more high priority operation areas at the worksite 101. It may be understood that charging stations S1-S4 may be set-up at the predefined locations and include a predefined number of the charging points 125 and/or rails 130 as determined by the identification module 450.

The assignment module 455 may be configured to receive the battery information from the battery electric machines 105, 110 respectively via the network 120 and the transceiver 445. It may be apparent that the battery electric machines 105, 110 may respectively include one or more hardware and/or software components such as, but not limited to, the transceiver 445, to provide the battery information to the dispatch system 115 via the network 120. It may also be understood that the battery electric machines 105, 110 may also include the components 405-440 of the dispatch system 115. In some embodiments, the battery electric machines 105, 110 may be configured to provide the battery information to the dispatch system 115 continuously in real-time or periodically. In some embodiments, the storage unit 425 may be configured to store and/or update the battery information received from the battery electric machines 105, 110. For example, the storage unit 425 may be configured to store and/or update the number of battery charge cycle and the amount of battery charge corresponding to each battery electric machine. The amount of battery charge of each battery electric machine may correspond to the amount of electrical charge or energy stored in one or more batteries provided in each battery electric machine.

In some embodiments, the assignment module 455 may be configured to determine a total number of the battery electric machines 105, 110 provided at the work site 101 (see FIG. 1). In some embodiments, the assignment module 455 may also be configured to determine the battery charging capacity associated with each battery electric machine based on the number of battery charge cycle. The battery charging capacity may correspond to a measure of the battery charge stored by a battery and is determined by a mass of an active material contained in the battery. In some embodiments, the battery charge capacity may represent a maximum amount of energy that can be extracted from the battery under predefined conditions. In some embodiments, the assignment module 455 may be configured to determine the battery charging capacity based on, but not limited to, battery type, battery age, battery history, battery charging and/or discharging regimes, and/or battery temperature. In some embodiments, the assignment module 455 may also be configured to determine the operating range of each battery electric machine based on the amount of battery charge. The operating range may correspond to a distance each battery electric machine can travel before a state of charge (SoC), or a remaining quantity of battery energy becomes equal to zero.

In some embodiments, the assignment module 455 may also be configured to determine a predefined target battery charge for each battery electric machine based on the amount of battery charge. In some embodiments, the predefined target battery charge may correspond to, but not limited to, the amount of battery charge required by each battery electric machine to perform the operation(s) assigned to each battery electric machine, or a predefined amount of battery charge to be provided to each battery electric machine. In some embodiments, the predefined target battery charge may correspond to 60 to 80 percent of the battery charging capacity in each battery electric machine. In some embodiments, the predefined target battery charge may be same or different for each battery electric machine. In some embodiments, the assignment module 455 may also be configured to determine if the amount of battery charge in each battery electric machine is equal to or less than a predefined threshold battery charge. In some embodiments, the predefined threshold battery charge may correspond to 20 percent of the battery charging capacity in each battery electric machine. In some embodiments, the predefined threshold battery charge may be same or different for each battery electric machine. In some embodiments, the processor 410 may also be configured to determine if the amount of battery charge in each battery electric machine is equal to or greater than the predefined target battery charge. In some embodiments, the assignment module 455 may also be configured to determine and/or assign a criticality of the amount of the battery charge based on the predefined threshold battery charge. For example, the processor 410 may be configured to determine and/or assign the criticality as “very critical”, “critical”, and “not critical” for instances when the amount of battery charge in each battery electric machine is less than, equal to, and greater than the predefined threshold battery charge respectively.

Based on the battery information, the assignment module 455 may be configured to assign at least one of the first battery electric machines 105 for operation and station at least one of the second battery electric machines 110 at least one of the charging stations, for example, S1 to S4 (see FIG. 1). In some embodiments, the assignment module 455 may be configured to assign the first battery electric machines 105 for operation when the amount of battery charge in the first battery electric machines 105 is equal to or greater than the amount of battery charge in the second battery electric machines 110. In some embodiments, the assignment module 455 may be configured to station the second battery electric machines 110 at the charging stations S1-S4 when the amount of battery charge in the second battery electric machines 110 is equal to or less than the amount of battery charge in the first battery electric machines 105.

In some embodiments, the amount of battery charge or an average amount of battery charge in the battery electric machines 105, 110 may be equal or substantially equal, and the assignment module 455 may be configured to determine a predetermined number of the first battery electric machines 105 and the second battery electric machines 110 for operation and stationing respectively based one or more operational parameters. Examples of the operational parameters include, but are not limited to, a number of available operators, the operation(s) to be performed at the work site 101 (see FIG. 1), a number of the operation(s) to be performed or locations at which the operation(s) are to be performed at the work site 101, a time required or assigned to complete the operation(s), and the criticality of the operation(s) to be performed.

For example, in some embodiments, the predetermined number of the first battery electric machines 105 assigned for operation may correspond to the number of available operators. For example, the total number of the battery electric machines 105, 110 provided at and in a vicinity of a charging station, for example, S1, to perform the operation(s) may be equal to 16 and a number of the available operators to operate the battery electric machines 105, 110 may be equal to 10. The assignment module 455 may then be configured to assign ten first battery electric machines 105 for operation and station six secondary battery electric machines 110 at the charging station, for example, S1. In some embodiments, an operator count of the number of available operators may be less than the total number of the battery electric machines 105, 110 provided at the work site 101.

In another example, in some embodiments, the predetermined number of the first battery electric machines 105 assigned for operation may correspond to the number of operations to be performed at the work site 101. For example, the total number of the battery electric machines 105, 110 provided at and in a vicinity of a charging station, for example, S1, to perform the operation(s) may be equal to 16 and a number of the operations to be performed may be equal to 10. The processor 410 may then be configured to assign ten first battery electric machines 105 for operation and station six secondary battery electric machines 110 at the charging station, for example, S1.

In some embodiments, based on the battery information, the assignment module 455 may also be configured to assign the stationed second battery electric machines 110 for charging or to be on stand-by at the charging stations S1, S2, S3, and/or S4. In some embodiments, the assignment module 455 may be configured to provide instructions to the second battery electric machines 110 to provide an audio and/or visual alert and/or notification to charge the second battery electric machines 110 or keep the second battery electric machines 110 on stand-by.

In some embodiments, the assignment module 455 may be configured to assign the stationed second battery electric machines to a corresponding unused charging point of the one or more charging points 125 (see FIG. 2) or an unoccupied space along a charging rail of the one or more charging rails 130 (see FIG. 3). In some embodiments, the assignment module 455 may be configured to assign the stationed second battery electric machines to a first row 125-1 of multiple charging points 125 or a first charging rail 130-1 of the charging rails 130.

In some embodiments, the assignment module 455 may also be configured to monitor the battery information received from the battery electric machines 105, 110. For instances when the assignment module 455 determines that the amount of battery charge of the battery electric machines 105, 110 is equal to, less than, or greater than the predefined threshold battery charge or the predefined target battery charge, the assignment module 455 may be configured to trigger and/or alert the dispatch module 460.

The dispatch module 460 may be configured to selectively recall at least one first battery electric machine 105 to a designated charging station, for example, S1. The dispatch module 460 may also be configured to selectively dispatch at least one second battery electric machine 110 for operation from the charging station, for example S1. It may be understood that the dispatch module 460 may be configured to selectively recall and/or dispatch the battery electric machines 105 and/or 110 by providing instructions to the battery electric machines 105 and/or 110 via the transceiver 445 and the network 120. In some embodiments, prior to the dispatch of the stationed second battery electric machine(s) 110, the dispatch module 460 may be configured to selectively recall the assigned first battery electric machine(s) 105 to the designated charging station, for example, S1, in order to facilitate a transfer of the operators operating the recalled first battery electric machine(s) 110 to the stationed second battery electric machines 110 to be dispatched. For purposes of clarity and understanding, the selectively recall and dispatch of the battery electric machines 105 and/or 110 by the dispatch module 460 at the charging station S1 is described herein. It may be understood that the dispatch module 460 may be configured to perform similar functions at the remaining charging stations, for example, S2, S3, and S4.

In some embodiments, the dispatch module 460 may be configured to identify the assigned first battery electric machines 105 and a number of the assigned first battery electric machines 105 having a battery charge substantially equal to, equal to, or less than the respective predefined threshold battery charge. The dispatch module 460 may also be configured to identify the stationed second battery electric machines 110 and a number of the stationed second battery electric machines 110 having a battery charge equal to or greater than the respective predefined target battery charge. The dispatch module 460 may then be configured to selectively recall a first number of the identified first battery electric machines 105 to the charging station S1. The dispatch module 460 may also be configured to selectively dispatch a second number of the identified second battery electric machines 110 from the charging station S1. In some embodiments, the first number may be equal to or different from the second number. In some embodiments, the dispatch module 460 may also be configured to recall the assigned first battery electric machines 105 charging station S1 for instances when the battery charge of the assigned first battery electric machines 105 is less than or equal to the battery charge of the identified second battery electric machines 110 dispatched for operation.

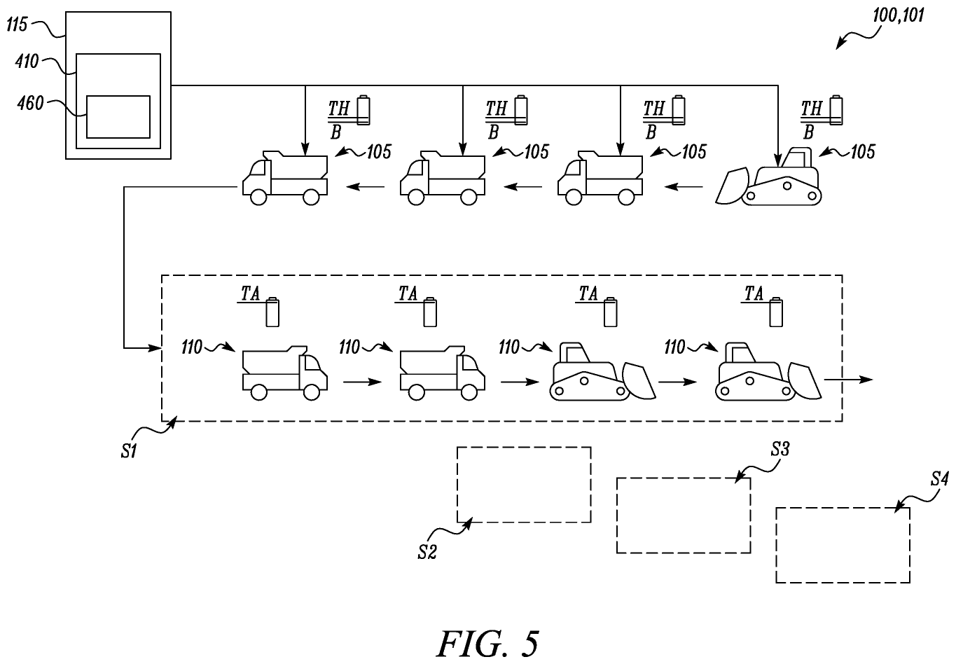

As an example, referring to FIG. 5, the dispatch module 460 may identify four first battery electric machines 105 having a battery charge ‘B’ less than or equal to the respective predefined threshold battery charge ‘TH’. The dispatch module 460 may also identify one or more designated charging stations that are in physical proximity to the four identified first battery electric machines 105. In some embodiments, dispatch module 460 may be configured to determine a distance between the four identified first battery electric machines 105 and the charging stations S1-S4 to identify the physical proximity and the designated charging station for each of the four identified first battery electric machines 105. As an example, the dispatch module 460 may be configured to identify the charging station S1, that is in physical proximity and/or closer to the identified first battery electric machines 105 in distance in comparison to remaining charging stations S2-S4, as the designated charging station. The dispatch module 460 may then be configured to identify four second battery electric machines 110 having a battery charge greater than the respective predefined target battery charge ‘TA’ at the charging station S1. The dispatch module 460 may then be configured to selectively recall the four identified first battery electric machines 105 to the charging station S1 and selectively dispatch the four identified second battery electric machines 110 for operation from the charging station S1.

In another example, the dispatch module 460 may identify four first battery electric machines 105 having a battery charge ‘B’ less than or equal to the respective predefined threshold battery charge. The dispatch module 460 may identify the charging station S1, that is in physical proximity and/or closer to the identified first battery electric machines 105 in distance in comparison to remaining charging stations S2-S4, as the designated charging station. The dispatch module 460 may then be configured to identify five second battery electric machines 110 having a battery charge greater than the respective predefined target battery charge ‘TA’ at the charging station S1. The dispatch module 460 may then be configured to selectively recall the four identified first battery electric machines 105 to the charging station S1 and selectively dispatch any four of the five identified second battery electric machines 110 for operation from the charging station S1. In some embodiments, dispatch module 460 may be configured to identify the four second battery electric machines 110 of the five identified second battery electric machines 110 for selective dispatch by comparing one or more selection parameters of the five identified second battery electric machines 110 respectively. Examples of the selection parameters include, but are not limited to, the battery charging capacity, the amount of battery charge, the number of battery charge cycle, the operating range, the machine type required, the operation to be performed, a time required to complete the operation, or a criticality of the operation.

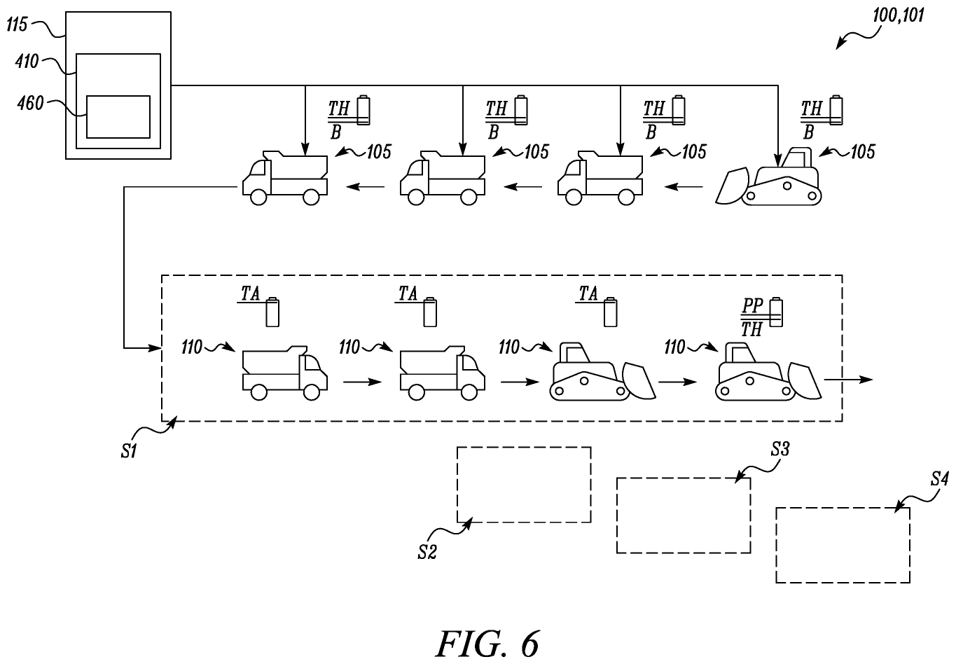

Referring to FIG. 6, in yet another example, the dispatch module 460 may identify four first battery electric machines 105 having a battery charge ‘B’ less than or equal to the respective predefined threshold battery charge ‘TM’. The dispatch module 460 may identify the charging station S1, that is in physical proximity and/or closer to the identified first battery electric machines 105 in distance in comparison to remaining charging stations S2-S4, as the designated charging station. The dispatch module 460 may then identify three second battery electric machines 110 having a battery charge greater than the respective predefined target battery charge ‘TA’ at the charging station S1. The dispatch module 460 may also be configured to identify a fourth second battery electric machine 110 having a battery charge equal to or greater than a predefined percentage ‘PP’ of the predefined threshold battery charge ‘TH’ determined for the fourth second battery electric machine 110. For example, the predefined percentage ‘PP’ may be equal to 40 percent, the predefined threshold battery charge ‘TH’ for the fourth second battery electric machine 110 may be equal to 20 percent, the predefined target battery charge for the fourth second battery electric machine 110 may be equal to 80 percent, and the determined battery charge of the fourth second battery electric machine 110 based on the battery information received may be equal to 50 percent. The dispatch module 460 may be configured to determine that the determined battery charge of 50 percent of the fourth second battery electric machine 110 is greater than the predefined percentage ‘PP’ of 40 percent. Accordingly, the dispatch module 460 may be configured to selectively recall the four identified first battery electric machines 105 to the charging station S1 and selectively dispatch the three identified second battery electric machines 110 for operation from the charging station S1. The dispatch module 460 may also selectively dispatch the fourth identified second battery electric machine 110 having the battery charge greater than the predefined battery charge and less than the predefined target battery charge.

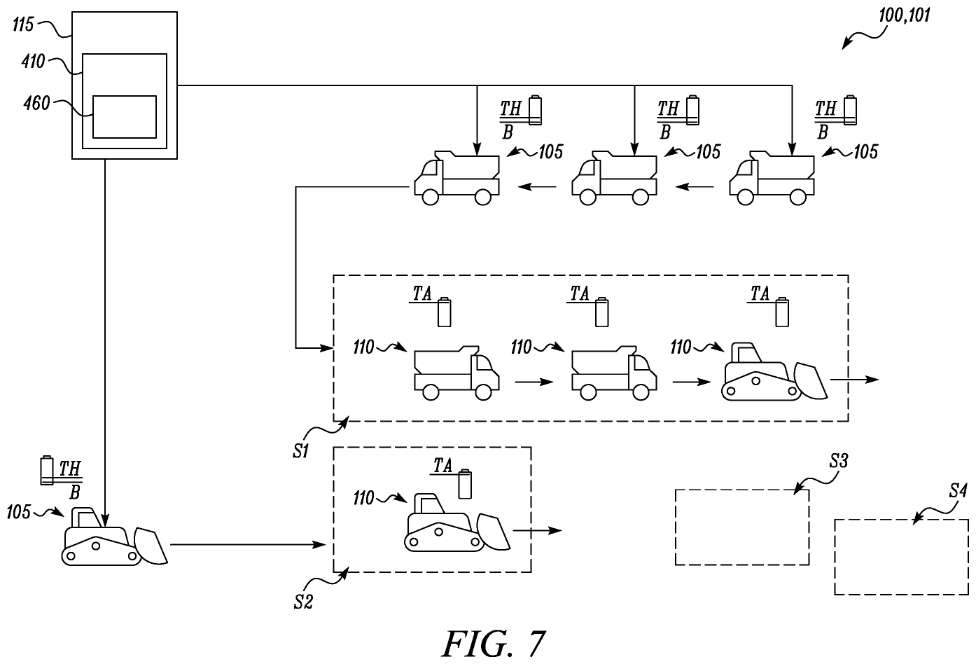

Referring to FIG. 7, in yet another example, the dispatch module 460 may identify four first battery electric machines 105 having a battery charge ‘B’ less than or equal to the respective predefined threshold battery charge ‘TH’. The dispatch module 460 may identify the charging station S1, that is in physical proximity and/or closer to the identified first battery electric machines 105 in distance in comparison to remaining charging stations S2-S4, as the designated charging station. The dispatch module 460 may then identify three second battery electric machines 110 having a battery charge greater than the respective predefined target battery charge ‘TA’ at the charging station S1. Further, the dispatch module 460 may identify that the remaining second battery electric machines 110 may have a battery charge that is less than the predefined percentage ‘PP’ of the predefined threshold battery charge ‘TH’. The dispatch module 460 may then be configured to identify another designated station, for example, S2 (see FIG. 1) that is greater in distance from a candidate first battery electric machine 105 of the four identified first battery electric machines 105 than the designated charging station S1 and lesser in distance from the candidate first battery electric machine 105 than the remaining charging stations, for example, S3 and S4. The dispatch module 460 may also be configured to determine availability of a second battery electric machine 110 having a battery charge greater than the predefined target battery charge ‘TA’ at the other designated station S2 identified. The dispatch module 460 may also be configured to determine the operating range of the candidate first battery electric machine 105 based on the battery charge of the candidate first battery electric machine 105.

Further, dispatch module 460 may also be configured to determine whether the operating range determined is equal to or less than the distance between the candidate first battery electric machine 105 and the other designated charging station S2. Based on the identification of the other designated charging station S2, the determination of the availability, and the determination of the operating range of the candidate first battery electric machine 105, the dispatch module 460 may be configured to selectively recall the candidate first battery electric machine 105 to the other designated charging station S2 identified and selectively dispatch the available second battery electric machine 110 for operation from the other designated charging station S2. The dispatch module 460 may also be configured to selectively recall the remaining three of the four identified first battery electric machines 105 to the charging station S1 and selectively dispatch the three identified second battery electric machines 110 for operation from the charging station S1.

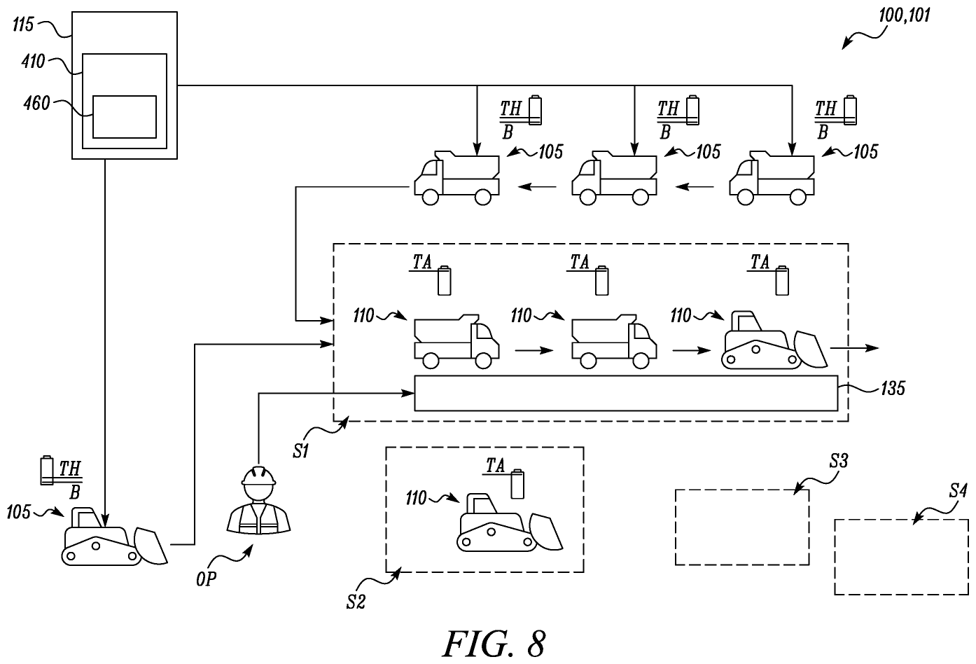

Referring to FIG. 8, in some embodiments, the determined operating range of the candidate first battery electric machine 105 may be less than the distance between the candidate first battery electric machine 105 and the other designated charging station S2 and greater than or equal to the distance between the candidate first battery electric machine 105 and the designated charging station S1. The dispatch module 460 may then be configured to selectively recall the candidate first battery electric machine 105 to the designated charging station S1 and queue the candidate first battery electric machine 105 for charging at the designated charging station S1 until a candidate second battery electric machine 110 stationed at the designated charging station S1 is available. The dispatch module 460 may be configured to identify the availability of the candidate second battery electric machine 110 based on the battery charge of the candidate second battery electric machine 110 and determining whether the battery charge of the candidate second battery electric machine 110 is greater than or equal to the predefined percentage or the predefined target battery charge. Upon identifying the availability of the candidate second battery electric machine 110, the dispatch module 460 may be configured to station the candidate first battery electric machine 105 for charging at the designated charging station S1 and dispatch the candidate second battery electric machine 110 for operation from the designated charging station S1. It may be understood that the operator ‘OP’ operating the candidate first battery electric machine 105 may utilize the operator room 135 (see FIG. 1) provided at the designated charging station S1 when the candidate first battery electric machine 105 is in queue and/or until the availability of the candidate second battery electric machine 110 is identified.

In some embodiments, the dispatch module 460 may also be configured to selectively recall and dispatch the battery electric machines 105 and/or 110 upon completion of a predefined period. In some embodiments, the dispatch module 460 may determine the predefined period for each battery electric machine. In some embodiments, the predefined period for each battery electric machine or at least some of battery electric machines may be same or different. In some embodiments, the dispatch module 460 may determine the predefined period based on one or more scheduling parameters. Examples of the scheduling parameters include, but are not limited to, the battery charging capacity, the amount of battery charge, the number of battery charge cycle, the operating range determined based on the amount of the battery charge, the machine type, the operation to be performed, the time required to complete the operation, or the criticality or a priority of the operation or the amount of the battery charge determined corresponding to each battery electric machine. In some embodiments, the predefined period may correspond to, but is not limited to, a time taken for the amount of battery charge of at least one of the stationed second battery electric machines 110 to be equal to the target battery charge, or the time taken for the amount of the battery charge of at least one of the assigned first battery electric machines 105 to be equal to the respective threshold battery charge.

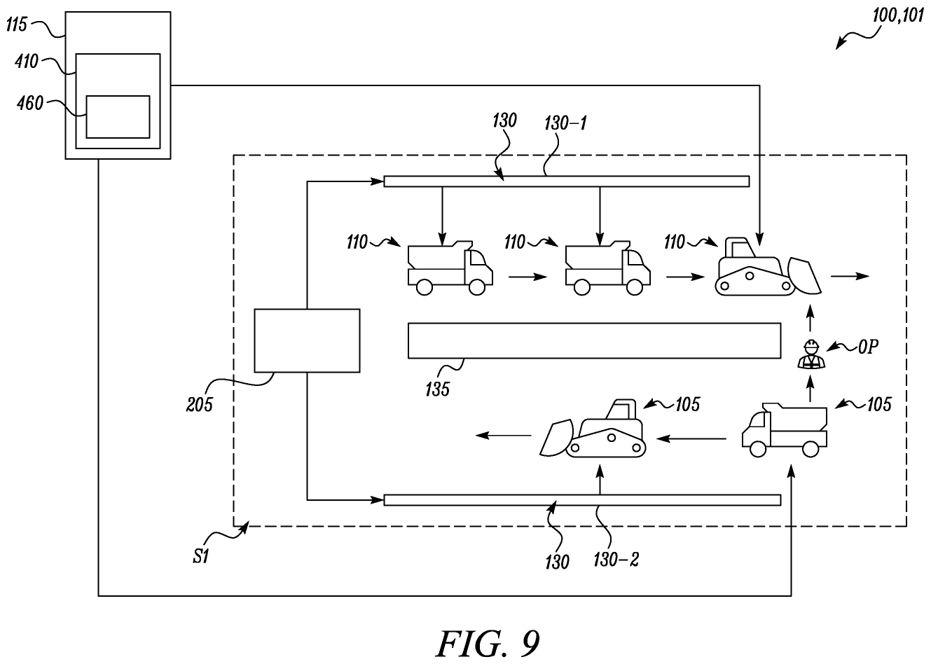

Referring to FIG. 9, in some embodiments, the dispatch module 460 may be configured to selectively recall at least one assigned first battery electric machine 105 to the second charging rail 130-2 of the charging rails 130 at the designated charging station S1. The dispatch module 460 may also be configured to selectively dispatch at least one stationed second battery electric machine 110 for operation from the first charging rail 130-1. In some embodiments, the dispatch module 460 may be configured to selectively recall the assigned first battery electric machine(s) 105 to the charging station S1 prior to selectively dispatching the stationed second battery electric machine(s) 110. In some embodiments, the prior selective recall of the assigned first battery electric machine(s) 105 to the charging station S1 may facilitate a transfer of the operator(s) ‘OP’ operating the recalled first battery electric machine(s) to the stationed second battery electric machine(s) 110 selected for dispatch respectively.

In some embodiments, the dispatch module 460 may also be configured to selectively recall the dispatched second battery electric machines 110 to the identified designated charging station, for example, S1 and selectively dispatch the recalled first battery electric machines 110 from the designated charging station S1. It may be understood that the dispatch module 460 may perform the functions of selectively recalling the dispatched second battery electric machines 110 to the identified designated charging station S1 and selectively dispatching the recalled first battery electric machines 110 from the designated charging station S1 similar to the functions of selectively recalling the assigned first battery electric machines 105 to the identified designated charging station S1 and selectively dispatching the stationed second battery electric machines 110 from the designated charging station S1 as described in the preceding disclosure and as shown in FIGS. 5-8. More specifically, the dispatch module 460 may be configured to selectively recall the dispatched second battery electric machines 110 to the identified designated charging station, for example, S1 and selectively dispatch the recalled first battery electric machines 105 from the designated charging station S1 based on the predefined threshold battery charge, the predefined target battery charge, and/or the predefined period determined corresponding to the recalled first battery electric machines 105 and/or the dispatched second battery electric machines 110 and as described in the preceding disclosure in respect of the assigned first battery electric machines 105 and/or the stationed second battery electric machines 110.

For example, in some embodiments, the dispatch module 460 may be configured to identify the dispatched second battery electric machines 110 and a number of the dispatched second battery electric machines 110 having a battery charge substantially equal to, equal to, or less than the respective predefined threshold battery charge. The dispatch module 460 may also be configured to identify the recalled first battery electric machines 105 and a number of the recalled first battery electric machines 105 having a battery charge equal to or greater than the respective predefined target battery charge. The dispatch module 460 may then be configured to selectively recall a third number of the identified second battery electric machines 110 to the charging station S1. The dispatch module 460 may also be configured to selectively dispatch a fourth number of the identified first battery electric machines 105 from the charging station S1. In some embodiments, the third number may be equal to or different from the fourth number. In some embodiments, the dispatch module 460 may also be configured to recall the dispatched second battery electric machines 110 to the charging station S1 for instances when the battery charge of the dispatched second battery electric machines 110 is less than or equal to the battery charge of the identified first battery electric machines 105 dispatched for operation.

As an example, the dispatch module 460 may identify four dispatched second battery electric machines 110 having a battery charge less than or equal to the respective predefined threshold battery charge. The dispatch module 460 may also identify one or more designated charging stations that are in physical proximity to the four identified second battery electric machines 110. In some embodiments, dispatch module 460 may be configured to determine a distance between the four identified second battery electric machines 110 and the charging stations S1-S4 to identify the physical proximity and the designated charging station for each of the four identified second battery electric machines 110. As an example, the dispatch module 460 may be configured to identify the charging station S1, that is in physical proximity and/or closer to the identified second battery electric machines 110 in distance in comparison to remaining charging stations S2-S4, as the designated charging station. The dispatch module 460 may then be configured to identify four recalled first battery electric machines 105 having a battery charge greater than the respective predefined target battery charge at the charging station S1. The dispatch module 460 may then be configured to selectively recall the four identified second battery electric machines 110 to the charging station S1 and selectively dispatch the four identified first battery electric machines 105 for operation from the charging station S1.

In another example, the dispatch module 460 may identify four dispatched second battery electric machines 110 having a battery charge less than or equal to the respective predefined threshold battery charge. The dispatch module 460 may identify the charging station S1, that is in physical proximity and/or closer to the identified second battery electric machines 110 in distance in comparison to remaining charging stations S2-S4, as the designated charging station. The dispatch module 460 may then be configured to identify five recalled first battery electric machines 110 having a battery charge greater than or equal to the respective predefined target battery charge at the charging station S1. The dispatch module 460 may then be configured to selectively recall the four identified second battery electric machines 110 to the charging station S1 and selectively dispatch any four of the five identified first battery electric machines 105 for operation from the charging station S1. In some embodiments, the dispatch module 460 may be configured to identify the four first battery electric machines 105 of the five identified first battery electric machines 105 for selective dispatch by comparing the selection parameters of the five identified first battery electric machines 105 respectively.

In yet another example, the dispatch module 460 may identify four dispatched second battery electric machines 110 having a battery charge less than or equal to the respective predefined threshold battery charge. The dispatch module 460 may also identify the charging station S1, that is in physical proximity and/or closer to the identified first battery electric machines 105 in distance in comparison to remaining charging stations S2-S4, as the designated charging station. The dispatch module 460 may then identify three first battery electric machines 105 having a battery charge greater than or equal to the respective predefined target battery charge at the charging station S1. The dispatch module 460 may also be configured to identify a fourth first battery electric machine 105 having a battery charge equal to or greater than a predefined percentage of the predefined threshold battery charge determined for the fourth first battery electric machine 105. For example, the predefined percentage may be equal to 40 percent, the predefined threshold battery charge for the fourth first battery electric machine 105 may be equal to 20 percent, the predefined target battery charge for the fourth first battery electric machine 105 may be equal to 80 percent, and the determined battery charge of the fourth first battery electric machine 105 based on the battery information received may be equal to 50%. The dispatch module 460 may be configured to determine that the determined battery charge of 50 percent of the fourth first battery electric machine 105 is greater than the predefined percentage of 40 percent. Accordingly, the dispatch module 460 may be configured to selectively recall the four identified second battery electric machines 110 to the charging station S1 and selectively dispatch the three identified first battery electric machines 105 for operation from the charging station S1. The dispatch module 460 may also selectively dispatch the fourth identified first battery electric machine 105, having the battery charge greater than the predefined battery charge and less than the predefined target battery charge, for operation.

In yet another example, the dispatch module 460 may identify four dispatched second battery electric machines 110 having a battery charge less than or equal to the respective predefined threshold battery charge. The dispatch module 460 may identify the charging station S1, that is in physical proximity and/or closer to the identified first battery electric machines 105 in distance in comparison to remaining charging stations S2-S4, as the designated charging station. The dispatch module 460 may then identify three recalled first battery electric machines 110 having a battery charge greater than or equal to the respective predefined target battery charge at the charging station S1. Further, the dispatch module 460 may identify that the remaining recalled first and/or stationed second battery electric machines 105, 110 at the charging station S1 may have a battery charge that is less than or equal to the predefined percentage of the predefined threshold battery charge. The dispatch module 460 may then be configured to identify another designated station, for example, S2 (see FIG. 1) that is greater in distance from a candidate second battery electric machine 110 of the four identified second battery electric machines 110 than the designated charging station S1 and lesser in distance from the candidate second battery electric machine 110 than the remaining charging stations, for example, S3 and S4. The dispatch module 460 may also be configured to determine availability of a recalled first battery electric machine 105 or a stationed second battery electric machine 110 having a battery charge greater than or equal to the respective predefined target battery charge at the other designated charging station S2 identified. The dispatch module 460 may also be configured to determine the operating range of the candidate second battery electric machine 110 based on the battery charge of the candidate second battery electric machine 110. Further, dispatch module 460 may also be configured to determine whether the operating range determined is equal to or less than the distance between the candidate second battery electric machine 110 and the other designated charging station S2. Based on the identification of the other designated charging station S2, the determination of the availability, and the determination of the operating range of the candidate second battery electric machine 110, the dispatch module 460 may be configured to selectively recall the candidate second battery electric machine 110 to the other designated charging station S2 identified and selectively dispatch the available recalled first battery electric machine 105 or stationed second battery electric machine 110 for operation from the other designated charging station S2. The dispatch module 460 may also be configured to selectively recall the remaining three of the four identified second battery electric machines 110 to the charging station S1 and selectively dispatch the three identified first battery electric machines 105 for operation from the charging station S1.

In some embodiments, the determined operating range of the candidate second battery electric machine 110 may be less than the distance between the candidate second battery electric machine 110 and the other designated charging station S2 and greater than or equal to the distance between the candidate second battery electric machine 110 and the designated charging station S1. The dispatch module 460 may then be configured to selectively recall the candidate second battery electric machine 110 to the designated charging station S1 and queue the candidate second battery electric machine 110 for charging at the designated charging station S1 until a candidate recalled first battery electric machine 105 stationed at the designated charging station S1 is available. The dispatch module 460 may be configured to identify the availability of the candidate recalled first battery electric machine 105 based on the battery charge of the candidate recalled first battery electric machine 105 and determining whether the battery charge of the candidate recalled first battery electric machine 105 is greater than or equal to the predefined percentage or the respective predefined target battery charge. Upon identifying the availability of the candidate recalled first battery electric machine 105, the dispatch module 460 may be configured to station the candidate second battery electric machine 110 for charging at the designated charging station S1 and dispatch the candidate recalled first battery electric machine 105 for operation from the designated charging station S1.

In some embodiments, the dispatch module 460 may also be configured to selectively recall the dispatched second battery electric machines 110 and dispatch the recalled first battery electric machines 105 upon completion of the predefined period. In some embodiments, the predefined period may correspond to, but is not limited to, a time taken for the amount of battery charge of at least one of the recalled first battery electric machines 105 to be equal to the respective target battery charge, or time taken for the amount of the battery charge of at least one of the dispatched second battery electric machines 110 to be equal to the respective threshold battery charge.

In some embodiments, the dispatch module 460 may also be configured to selectively recall the assigned first battery electric machine(s) 105 or the dispatched second battery electric machines 110 and dispatch the stationed second battery electric machine(s) 110 or the recalled first battery electric machines 105 based on the power capacity of the power unit(s) 205 (see FIGS. 2-3) provided at the charging station S1. For example, the dispatch module 460 may be configured to determine a total power load applied by the charging battery electric machines 105, 110 at the charging station S1. The power load may correspond to the electrical energy consumed by the battery electric machines 105, 110 at the charging station S1 via the charging points 125 or rails 130. Accordingly, the dispatch module 460 may be configured to recall and/or dispatch the battery electric machines 105, 110 from the charging station S1 when the total power load is greater than or equal to a predefined power load. It may be understood that the predefined power load may be less than the power capacity of power unit(s) 205 at the charging station S1.

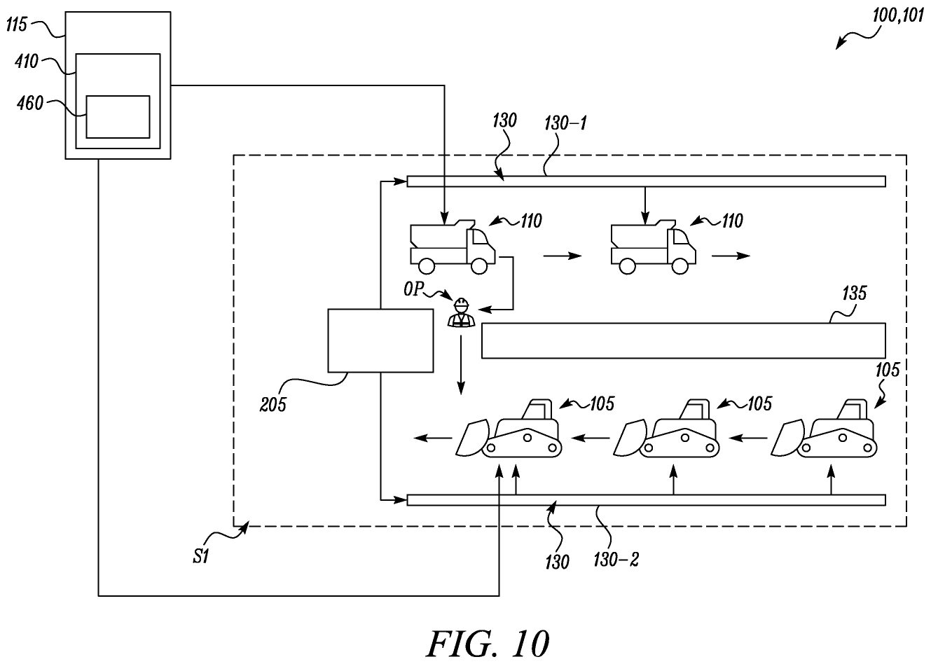

Referring to FIG. 10, in some embodiments, the dispatch module 460 of FIG. 4 may be configured to selectively recall at least one dispatched second battery electric machine 110 to the first charging rail 130-1 of the charging station S1. The dispatch module 460 may also be configured to selectively dispatch at least one recalled first battery electric machine 105 for operation from the second charging rail 130-2 of the charging station S1. In some embodiments, the dispatch module 460 may be configured to determine a number of the remaining stationed second battery electric machines 110 connected to the first charging rail 130-1 after the selective dispatch of each second battery electric machine(s) 110. In some embodiments, the dispatch module 460 may also be configured to determine a number of the recalled first battery electric machine(s) 105 connected to the second charging rail 130-2. Further, in some embodiments, the dispatch module 460 may also be configured to determine a predefined number of the battery electric machines 105 and/110 capable of being accommodated in each charging rail, for example, 130-1, of the charging rails 130. Accordingly, in some embodiments, the dispatch module 460 may be configured to selectively recall the dispatched second battery electric machine(s) to the first charging rail 130-1 when the number of the remaining stationed second battery electric machines 110 connected to the first charging rail is less than the predefined number, or to the second charging rail 130-2 when the number of the recalled first battery electric machine(s) connected to the second charging rail 130-2 is less than the predefined number. Similarly, the dispatch module 460 may also be configured to selectively dispatch at least one of a remaining number of the stationed second battery electric machines 110 for operation from the first charging rail 130-1 or at least one of the recalled first battery electric machine(s) for operation from the second charging rail 130-2. In some embodiments, the dispatch module 460 may be configured to selectively recall the dispatched second battery electric machine(s) 110 to the charging station S1 prior to selectively dispatching the recalled first battery electric machine(s) 105. In some embodiments, the prior selective recall of the dispatched second battery electric machine(s) 110 to the charging station S1 may facilitate a transfer of the operator(s) ‘OP’ operating the recalled second battery electric machine(s) 110 to the recalled first battery electric machine(s) 105 selected for dispatch respectively.

In some embodiments, the dispatch module 460 may be configured to recall the dispatched second battery electric machine(s) to the first charging rail 130-1 for charging when a number of the recalled first battery electric machines 105 in the second charging rail 130-2 is equal to the predefined number or when a number of the dispatched second battery electric machines 110 from the first charging rail 130-1 is equal to the predefined number. Similarly, the dispatch module 460 may be configured dispatch the recalled first battery electric machine(s) for operation from the second charging rail 130-2 when a number of the recalled second battery electric machines 110 in the first charging rail 130-1 is equal to the predefined number or when a number of the recalled first battery electric machine(s) in the second charging rail 130-2 is equal to the predefined number. For example, the dispatch module 460 may determine the predefined number of the battery electric machines 105 and/110 capable of being accommodated in the first charging rails 130-1 to be equal to four. Accordingly, when the number of the dispatched second battery electric machines 110 from the first charging rail 130-1 is equal to four and/or when the number of the recalled first battery electric machines 105 in the second charging rail 130-2 is equal to four, the dispatch module 460 may be configured to recall the dispatched second battery electric machine(s) to the first charging rail 130-1. Similarly, when the number of the recalled second battery electric machines 110 in the first charging rail 130-1 is equal to four or when the number of the recalled first battery electric machine(s) in the second charging rail 130-2 is equal to four, the dispatch module 460 may be configured dispatch the recalled first battery electric machine(s) for operation from the second charging rail 130-2.

It may be understood that, in some embodiments, the dispatch module 460 may also be configured to selectively recall the battery electric machines 105, 110 to and/or dispatch the battery electric machines 105, 110 from the first row 125-1 and/or the second row 125-2 of charging points similar to selectively recalling the battery electric machines 105, 110 to and/or dispatching the battery electric machines 105, 110 from the first charging rail 130-1 and/or the second charging rail 130-2 as described in the preceding disclosure.

In some embodiments, the dispatch module 460 may be configured to determine the predefined number of the battery electric machines 105, 110 that can be accommodated in each charging station based on, but not limited to, a number of charging points 125 or charging rails 130, the length ‘L’ of the charging rails 130, and/or a length ‘L1’ of the battery electric machines 105, 110. In some embodiments, the dispatch module 460 may be configured to determine the predefined number continuously or periodically as and when the battery electric machines 105,110 are assigned, stationed, recalled, and/or dispatched. Accordingly, the dispatch module 460 may be configured to assign, station, recall, and/or dispatch the battery electric machines 105,110 such that a number of the battery electric machines 105, 110 at each charging station is substantially constant over time. In some embodiments, the dispatch module 460 may be configured to determine the constant number of battery electric machines 105, 110 to be maintained at each charging station. In some embodiments, the constant number of the battery electric machines 105, 110 to be maintained at each charging station may be predefined. In some embodiments, the substantially constant number of battery electric machines 105, 110 may correspond to a consistently optimal range of the number of the battery electric machines 105, 110 at each charging station that is at least less than one or two of, or equal to the constant number of the battery electric machines 105, 110 determined by the dispatch module 460 or predefined.

For example, the predefined number of the battery electric machines 105, 110 that can be accommodated in the charging station S1 as determined by the dispatch module 460 may be equal to four. Accordingly, the dispatch module 460 may be configured to assign and/or station the battery electric machines 105, 110 such that a total number of stationed second battery electric machines 110 and/or the recalled first battery electric machines 105 at the charging station S1 is equal to or substantially equal to four, for example, at least three or two, at any given point in time. Similarly, the dispatch module 460 may be configured to recall and/or dispatch the battery electric machines 105, 110 such that the total number of stationed second battery electric machines 110, a total number of the recalled second battery electric machines 110, and/or the total number of the recalled first battery electric machines 105 at the charging station S1 is equal to four or three at any given point in time.

It may be apparent that, in some embodiments, for instances when the number of the battery electric machines 105, 110 at each charging station is less than the predefined number determined by the dispatch module 460, the dispatch module 460 may be configured to recall one or more battery electric machines 105 and/or 110 such that the number of the battery electric machines 105 and/or 110 at each charging station is equal to the predefined number. Similarly, it may also be apparent that, in some embodiments, for instances when the number of the battery electric machines 105, 110 at each charging station is greater than the predefined number determined by the dispatch module 460, the dispatch module 460 may be configured to dispatch one or more battery electric machines 105 and/or 110 from the charging station S1 such that the number of the battery electric machines 105 and/or 110 at each charging station is equal to the predefined number.

Similarly, the dispatch module 460 may be configured to determine the predefined rail or row number of battery electric machines 105, 110 that can be accommodated at each row, for example 125-1, of the charging points 125 and/or each charging rail, for example, 130-1, of the charging rails 130 based on, but not limited to, the power capacity of the power unit(s) 205 and/or the charging points 125 or the charging rails 130, a number of the charging points 125 in each row, for example, 125-1, the length ‘L’ of the charging rails 130, and/or the length ‘L1’ of the battery electric machines 105, 110. In some embodiments, the dispatch module 460 may be configured to determine the predefined rail or row number continuously or periodically as and when the battery electric machines 105,110 are assigned, stationed, recalled, and/or dispatched. Accordingly, the dispatch module 460 may be configured to assign, station, recall, and/or dispatch the battery electric machines 105,110 such that a number of the battery electric machines 105, 110 at each charging rail, for example 130-1, of the charging rails 130 and/or each row, for example, 125-1, of the charging points 125 is substantially constant over time.

For example, the predefined number of battery electric machines 105, 110 that can be accommodated in the charging rail 130-1 as determined by the dispatch module 460 may be equal to four. Accordingly, the dispatch module 460 may be configured to assign and/or station the battery electric machines 105, 110 such that a total number of stationed second battery electric machines 110 and/or the recalled first battery electric machines 105 at the charging rail 130-1 is equal to or substantially equal to four, for example, at least three or two, at any given point in time. Similarly, the dispatch module 460 may be configured to recall and/or dispatch the battery electric machines 105, 110 such that the total number of stationed second battery electric machines 110, a total number of the recalled second battery electric machines 110, and/or the total number of the recalled first battery electric machines 105 at the charging rail 130-1 is equal to four or at least three or two at any given point in time.

It may be apparent that, in some embodiments, for instances when the number of the battery electric machines 105, 110 at each charging rail, for example, 130-1, is less than the predefined row or rail number determined by the dispatch module 460, the dispatch module 460 may be configured to recall one or more battery electric machines 105 and/or 110 to the charging rail 130-1 such that the number of the battery electric machines 105 and/or 110 at the charging rail 130-1 is equal to the predefined row or rail number. Similarly, it may also be apparent that, in some embodiments, for instances when the number of the battery electric machines 105, 110 at each charging rail, for example, 130-1, is greater than the predefined row or rail number determined by the dispatch module 460, the dispatch module 460 may be configured to dispatch one or more battery electric machines 105 and/or 110 from the charging rail 130-1 such that the number of the battery electric machines 105 and/or 110 at the charging rail 130-1 is equal to the predefined row or rail number.

### INDUSTRIAL APPLICABILITY

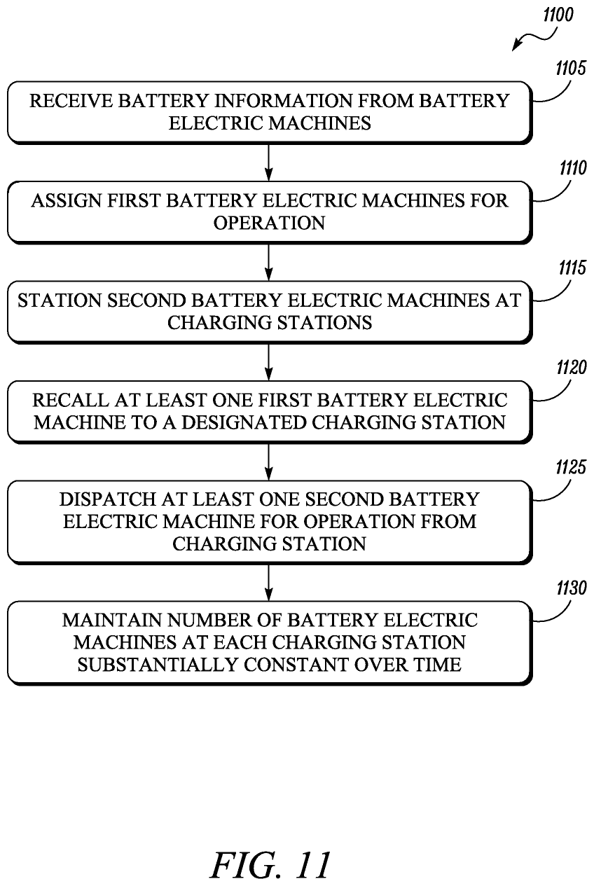

Referring to FIG. 11, an exemplary flowchart of a dispatch method 1100 for battery electric machines 105, 110 of FIG. 1 is disclosed. The dispatch method 1100 includes a step 1105 of receiving battery information from the battery electric machines 105, 110 respectively. Further, based on the battery information, the dispatch method 1100 includes a step 1110 of assigning the first battery electric machines 105 for operation. The dispatch method 1100 also includes a step 1115 of stationing the second battery electric machines 110 at the charging stations, for example, S1, S2, S3, and/or S4. In addition, the dispatch method 1100 includes a step 1120 of selectively recalling at least one assigned first battery electric machine to a designated charging station, for example, S1. The dispatch method 900 also includes a step 1125 of selectively dispatching at least one stationed second battery electric machine for operation. The steps 1120 and/or 1110 may further include a step 1130 of maintaining a number of the battery electric machines 105, 110 at each charging station, for example, S1, substantially constant over time.

It may be apparent that the system 100 of FIG. 1, the dispatch system 115 of FIG. 4, and the dispatch method 1100 of FIG. 11 of the present disclosure facilitate optimal utilization of the battery electric machines 105, 110, and/or the charging stations, for example, S1-S4 at the work site 101 by maintaining the number of battery electric machines 105, 110 substantially constant over time each charging station, charging points, and/or charging rails. It may also be apparent that the system 100 of FIG. 1, the dispatch system 115 of FIG. 4, and the dispatch method 1100 of FIG. 11 of the present disclosure facilitate optimal utilization of the available operators by facilitating the transfer from the operators from the recalled battery electric machines 105 and/or 110 having a battery charge less than or equal to the predefined battery charge to the battery electric machines 105 and/or 110 having a battery charge greater than or equal to the predefined target battery charge and selected for dispatch at each charging station. Moreover, the system 100 of FIG. 1, the dispatch system 115 of FIG. 4, and the dispatch method 1100 of FIG. 11 of the present disclosure also enable the operators to utilize the operator room(s) 135 for rest, recovery, and/or refreshment in-between transfers and/or while the battery electric machines 105 and/or 110 are in queue for charging at each charging station. It may also be apparent that the system 100 of FIG. 1, the dispatch system 115 of FIG. 4, and the dispatch method 1100 of FIG. 11 of the present disclosure may improve an overall productivity and efficiency of the operations performed at the work site 101 as a result of the optimal utilization of the available operators, the battery electric machines 105, 110 and/or the charging stations S1-S4.

Unless explicitly excluded, the use of the singular to describe a component, structure, or operation does not exclude the use of plural such components, structures, or operations or their equivalents. The use of the terms “a” and “an” and “the” and “at least one” or the term “one or more,” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B” or one or more of A and B”) is to be construed to mean one item selected from the listed items (A or B) or any combination of two or more of the listed items (A and B; A, A and B; A, B and B), unless otherwise indicated herein or clearly contradicted by context. Similarly, as used herein, the word “or” refers to any possible permutation of a set of items. For example, the phrase “A, B, or C” refers to at least one of A, B, C, or any combination thereof, such as any of: A; B; C; A and B; A and C; B and C; A, B, and C; or multiple of any item such as A and A; B, B, and C; A, A, B, C, and C; etc.

It will be apparent to those skilled in the art that various modifications and variations can be made to the method and/or system of the present disclosure without departing from the scope of the disclosure. Other embodiments will be apparent to those skilled in the art from consideration of the specification and practice of the method and/or system disclosed herein. It is intended that the specification and examples be considered as exemplary only, with a true scope of the disclosure being indicated by the following claims and their equivalent.

What is claimed is:

1. A dispatch system for a plurality of battery electric machines, the dispatch system comprising:
a processor;
a transceiver configured for communication with the plurality of battery electric machines;
a memory communicatively coupled to the processor, wherein the memory stores instructions which, upon execution by the processor, cause the processor to:
receive battery information from the plurality of battery electric machines respectively via the transceiver, wherein, based on the battery information, the processor is configured to:
assign one or more first battery electric machines of the plurality of battery electric machines for operation;
station one or more second battery electric machines of the plurality of battery electric machines at one or more charging stations;
selectively recall at least one assigned first battery electric machine of the one or more assigned first battery electric machines to a designated charging station of the one or more charging stations; and
selectively dispatch at least one stationed second battery electric machine of the one or more stationed second battery electric machines for operation from the one or more charging stations; and
wherein a number of the plurality of battery electric machines at each charging station of the one or more charging stations is substantially constant over time.

2. The dispatch system of claim 1, wherein the one or more first battery electric machines assigned for operation have a battery charge greater than or equal to the battery charge of one or more second battery electric machines stationed at the one or more charging stations.

3. The dispatch system of claim 1, wherein the one or more first battery electric machines are assigned for operation or charged after the recall, and the one or more second battery electric machines are stationed or dispatched for operation for a predefined period.

4. The dispatch system of claim 3, wherein the predefined period corresponds to a time taken for an amount of a battery charge of at least one of the one or more stationed or dispatched second battery electric machines to be equal to a target battery charge, or the amount of the battery charge of at least one of the one or more assigned or recalled first battery electric machines to be equal to a threshold battery charge.

5. The dispatch system of claim 3, wherein the processor is configured to determine the predefined period based on one or more scheduling parameters, the one or more scheduling parameters including at least one of a battery charging capacity, an amount of a battery charge, a number of a battery charge cycle, an operating range of the plurality of battery electric machines determined based on the amount of the battery charge, a machine type, the operation to be performed, a time required to complete the operation, or a criticality of the operation or the amount of the battery charge.

6. The dispatch system of claim 3, wherein the processor is configured to dispatch at least one of the one or more recalled first battery electric machines for operation and recall at least one of the one or more dispatched second battery electric machines to the one or more charging stations upon completion of the predefined period.

7. The dispatch system of claim 3, wherein the processor is configured to assign a priority to a task to be performed by the one or more assigned first battery electric machines and determine the predefined period based on the priority assigned.

8. The dispatch system of claim 1, wherein the one or more recalled first battery electric machines are charged or the one or more second battery electric machines are stationed until a battery charge of the one or more recalled first battery electric machines, or the one or more stationed second battery electric machines, is equal to a target battery charge.

9. The dispatch system of claim 8, wherein the processor is configured to determine the target battery charge for the one or more recalled first battery electric machines and the one or more stationed second battery electric machines based on one or more operational parameters, the one or more operational parameters including at least one of a battery charging capacity, an amount of a battery charge, a number of a battery charge cycle, an operating range of the plurality of battery electric machines based on the amount of the battery charge, a machine type, the operation to be performed, a time required to complete the operation, or a criticality of the operation or the amount of the battery charge.

10. The dispatch system of claim 1, wherein the at least one first battery electric machine of the one or more first battery electric machines is recalled when an amount of battery charge of the at least one first battery electric machine is equal to a predefined threshold battery charge.

11. The dispatch system of claim 1, wherein the designated charging station is closer to the at least one recalled first battery electric machine in distance in comparison to remaining charging stations of the one or more charging stations.

12. The dispatch system of claim 1, wherein the one or more charging stations are provided at one or more predefined locations and the processor is configured to determine the one or more predefined locations based on one or more set-up parameters, the one or more set-up parameters including at least one of one or more operations to be performed at a work site, a time required to complete the one or more operations, a frequency of the one or more operations to be performed, a criticality of the one or more operations to be performed, or a feasibility of installing the one or more charging stations at the work site.

13. The dispatch system of claim 1, wherein a number of operators available to operate the plurality of the battery electric machines is equal to a number of the one or more assigned first battery electric machines.

14. The dispatch system of claim 1, wherein, prior to the dispatch of the at least one stationed second battery electric machine, the processor is configured to recall the at least one first battery electric machine to facilitate transfer of an operator operating the at least one recalled first battery electric machine to the at least one stationed second battery electric machine to be dispatched.

15. The dispatch system of claim 1, wherein a number of available operators to operate the plurality of battery electric machines is less than a total number of the plurality of battery electric machines.

16. The dispatch system of claim 1, wherein the processor is configured to dispatch the at least one stationed second battery electric machine from the designated charging station for operation corresponding to the at least one recalled first battery electric machine.

17. The dispatch system of claim 1, wherein each charging station of the one or more charging stations comprises one or more charging points and, based on the battery information, the processor is configured to assign the one or more stationed second battery electric machines or the at least one recalled first battery electric machine to a corresponding unused charging point of the one or more charging points.

18. The dispatch system of claim 17, wherein a total number of the one or more stationed second battery electric machines and the at least one recalled battery electric machine assigned for charging corresponding to the one or more charging points at each charging station of the one or more charging stations is substantially constant over time.

19. The dispatch system of claim 1, wherein each charging station of the one or more charging stations comprises one or more charging rails and, based on the battery information, the processor is configured to assign the one or more stationed second battery electric machines or the at least one recalled first battery electric machine to the one or more charging rails.

20. The dispatch system of claim 19, wherein each charging rail of the one or more charging rails is configured to accommodate a predefined number of the plurality of battery electric machines.

21. The dispatch system of claim 20, wherein the one or more charging rails comprise at least two charging rails, the at least two charging rails comprising a first charging rail for the one or more stationed second battery electric machines and a second charging rail for the at least one recalled first battery electric machine.

22. The dispatch system of claim 21, wherein, when a number of the one or more recalled first battery electric machines in the second charging rail is equal to the predefined number or when a number of the one or more second battery electric machines dispatched from the first charging rail is equal to the predefined number, the processor is configured to dispatch the one or more recalled first battery electric machines for operation from the second charging rail and recall the at least one dispatched second battery electric machines to the first charging rail for charging.

23. A dispatch system for dispatching a plurality of battery electric machines from a charging station, the dispatch system comprising:
a processor;
a transceiver configured for communication with the plurality of battery electric machines;
a memory communicatively coupled to the processor, wherein the memory stores instructions which, upon execution by the processor, cause the processor to:
assign one or more first battery electric machines of the plurality of battery electric machines for operation, wherein the one or more first battery electric machines are operated by an operator respectively;
station one or more second battery electric machines of the plurality of battery electric machines at the charging station, wherein the charging station comprises one or more charging rails and the one or more second battery electric machines are stationed along a first charging rail of the one or more charging rails;
selectively recall at least one assigned first battery electric machine of the one or more assigned first battery electric machines to a second charging rail of the one or more charging rails; and
selectively dispatch at least one stationed second battery electric machine of the one or more stationed second battery electric machines for operation from the first charging rail, wherein the processor is configured to recall the at least one assigned first battery electric machine prior to selectively dispatching the at least one stationed second battery electric machine in order to facilitate a transfer of the operator operating the at least one recalled first battery electric machine to the at least one stationed second battery electric machine selected for dispatch,
and wherein a number of the plurality of battery electric machines along at least one charging rail of the one or more charging rails is substantially constant over time.

24. The dispatch system of claim 23, wherein the processor is configured to:
selectively recall the at least one dispatched second battery electric machine to the first charging rail; and
selectively dispatch the at least one recalled first battery electric machine for operation from the second charging rail.

25. The dispatch system of claim 23, wherein each charging rail of the one or more charging rails is configured to accommodate a predefined number of the plurality of battery electric machines.

26. The dispatch system of claim 25, wherein the processor is configured to:
determine a number of the stationed second battery electric machines connected to the first charging rail after the selective dispatch of the at least one second battery electric machine and a number of the at least one recalled first battery electric machine connected to the second charging rail.

27. The dispatch system of claim 26, wherein the processor is configured to:
selectively recall the at least one dispatched second battery electric machine to the first charging rail when the number of the stationed second battery electric machines connected to the first charging rail is less than the predefined number, or to the second charging rail when the number of the at least one recalled first battery electric machine connected to the second charging rail is less than the predefined number; and
selectively dispatch at least one of a remaining number of the stationed second battery electric machines from the first charging rail or the at least one recalled first battery electric machine for operation from the second charging rail.

28. A system for managing operation of a plurality of battery electric machines at a site, the system comprising:
one or more charging stations; and
a dispatch system for the plurality of battery electric machines, wherein the dispatch system is configured to:
receive battery information from the plurality of battery electric machines respectively, wherein, based on the battery information, the dispatch system is configured to:
assign one or more first battery electric machines of the plurality of battery electric machines for operation at the work site;
station one or more second battery electric machines of the plurality of battery electric machines at the one or more charging stations;
selectively recall at least one assigned first battery electric machine of the one or more assigned first battery electric machines to a designated charging station of the one or more charging stations; and
selectively dispatch at least one stationed second battery electric machine of the one or more stationed second battery electric machines for operation; and
wherein a number of the plurality of battery electric machines at each charging station of the one or more charging stations is substantially constant over time.

29. A dispatch method for a plurality of battery electric machines, comprising:
receiving battery information from the plurality of battery electric machines respectively; and based on the battery information:
assigning one or more first battery electric machines of the plurality of battery electric machines for operation;
stationing one or more second battery electric machines of the plurality of battery electric machines at one or more charging stations;
selectively recalling at least one of the one or more first battery electric machines to a designated charging station of the one or more charging stations; and
selectively dispatching at least one of the one or more second battery electric machines for operation; and
wherein the selectively recalling, selectively dispatching, or both the selectively recalling and dispatching comprises maintaining a number of the plurality of battery electric machines at each charging station of the one or more charging stations substantially constant over time.
